(19) United States
(12) Patent Application Publication
(10) Pub. No.: US 2009/0219585 A1
(43) Pub. Date: Sep. 3, 2009

(54) IMAGE READING APPARATUS AND IMAGE FORMING APPARATUS INCLUDING THE SAME

(76) Inventor: Tomohide HOZONO, Osaka (JP)

Correspondence Address: OSTROLENK FABER GERB & SOFFEN, 1180 AVENUE OF THE AMERICAS, NEW YORK, NY, 100368403, US

(21) Appl. No.: 12/394,512

(22) Filed: Feb. 27, 2009

(30) Foreign Application Priority Data
Feb. 29, 2008 (JP) 2008-049095

(51) Int. Cl. H04N 1/04

(52) U.S. Cl. 358/485; 358/474

(57) ABSTRACT

Provided is an image reading apparatus including: a document holding section for holding a document; and a carriage which moves with respect to the document holding section, the carriage including: a rod-like light source for irradiating the document with light; a light source mounting base for supporting the light source; a housing provided with a sensor for reading image data of the document and the light source mounting base; and a reflection plate including: a reflection curved surface portion for partially surrounding the light source to collect light emitted from the light source toward the document holding section; and a light reducing portion for reducing an amount of light at a longitudinal center portion of the light source with respect to the document holding section.

### INCORPORATION BY REFERENCE

This application is based upon and claims the benefit of priority from the corresponding Japanese Patent Application No. 2008-049095, filed Feb. 29, 2008, the entire contents of which is incorporated herein by reference.

### BACKGROUND OF THE INVENTION

1. Field of the Invention

The present invention relates to an image reading apparatus used in a image forming apparatuses typified by a copying machine, a facsimile, and the like, and to an image forming apparatus including the image reading apparatus.

2. Description of the Background Art

In this type of image reading apparatus, a document is held on a document holding section, and after a start button of the image forming apparatus is pushed, the document is optically read.

Further, in an image forming apparatus using an electrophotographic process, a photosensitive drum is charged in advance, and a surface of the photosensitive drum is irradiated with light to form an electrostatic latent image. Then, a toner image developed on the electrostatic latent image is transferred and fixed on a sheet.

Here, in order to read the document optically, the document holding section requires appropriate illuminance. For example, there is a technology in which a reflection plate having high glossiness property is installed around a rod-like light source, and in addition to direct light from the light source to the document holding section, reflected light from the reflection plate to a document surface is also used to obtain a desired cross-sectional light distribution in the document holding section.

Incidentally, the light source and the reflection plate described above are installed in a carriage that moves with respect to the document holding section. Specifically, a housing for the carriage is provided with a plurality of lenses and a mirror therein.

For example, a cold-cathode tube lamp is used for the rod-like light source. The cold-cathode tube lamp has such a characteristic that an amount of light at a center portion thereof in a longitudinal direction (tube length direction) is larger than an amount of light at both end portions thereof.

In other words, in the case where a cold-cathode tube lamp which is bright in a center portion thereof is used, the document cannot be evenly irradiated with light, with the result that there arises a problem in that image data of the read document may suffer from unevenness of the amount of light. This is because center portions of the above-mentioned lenses are also made bright and the brightness of the center portion is superimposed.

Accordingly, in a shading correction, the amount of light at the center portion is required to be reduced. However, in the above-mentioned technology, a large amount of light is merely collected in the document holding section, which has been an unsolved problem.

### SUMMARY OF THE INVENTION

The present invention has an object to provide an image reading apparatus executing an appropriate shading correction even when a rod-like light source such as a cold-cathode tube lamp is used, and an image forming apparatus including the image reading apparatus.

In order to achieve the object, an image reading apparatus according to an aspect of the present invention includes:

a document holding section for holding a document; and

a carriage that moves with respect to the document holding section, the carriage including:
a rod-like light source for irradiating the document with light;
a light source mounting base for supporting the light source;
a housing provided with a sensor for reading image data of the document and the light source mounting base; and
a reflection plate including:
   a reflection curved surface portion for partially surrounding the light source to collect light emitted from the light source toward the document holding section; and
   a light reducing portion for reducing an amount of light at a longitudinal center portion of the light source with respect to the document holding section.

### BRIEF DESCRIPTION OF THE DRAWINGS

In the accompanying drawings:

FIG. 1 is a perspective overview of an image forming apparatus according to an embodiment of the present invention;

FIG. 2 is a perspective overview of the image forming apparatus of FIG. 1 in a state in which a document holding section is visually identified;

FIG. 3 is a sectional view of the image forming apparatus of FIG. 1;

FIG. 4A is a partial sectional view of a scanner section of FIG. 3;

FIG. 4B is a “C” sectional view of FIG. 4A;

FIG. 5A is a perspective overview of the scanner section of FIG. 3;

FIG. 5B is a “D” sectional view of FIG. 5A; and

FIG. 6 is a perspective overview of a reflection plate of FIG. 5.

### DETAILED DESCRIPTION OF THE PREFERRED EMBODIMENT

Hereinafter, a description is made of an embodiment of the present invention with reference to the drawings.

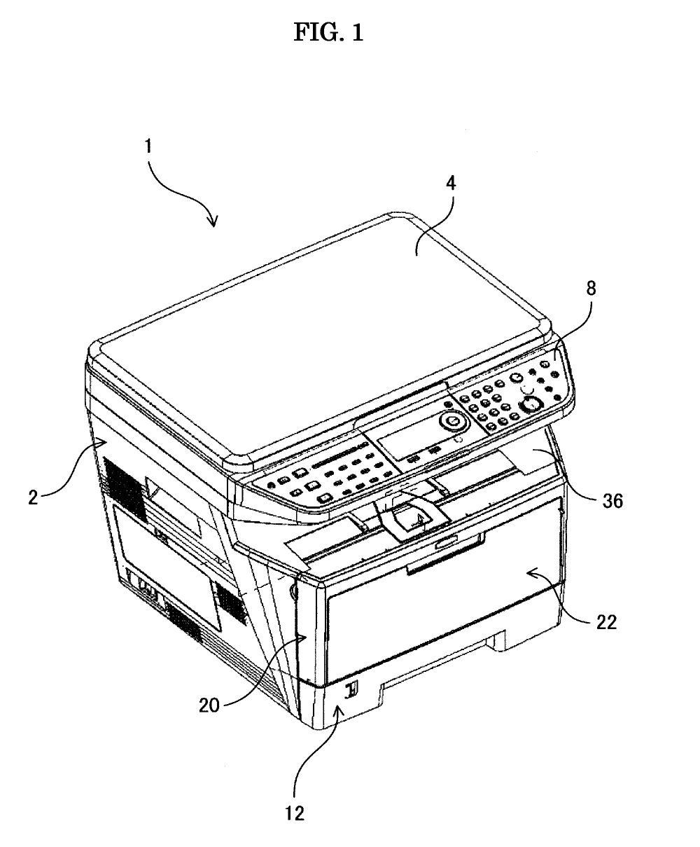

FIG. 1 illustrates a multifunction peripheral 1 as an example of an image forming apparatus viewed from a near upper left side, and a front of the multifunction peripheral 1 facing an operator and a left side of the multifunction peripheral 1 are viewed.

The multifunction peripheral 1 includes a device main body 2, and a sheet discharge tray 36 is formed in the device main body 2.

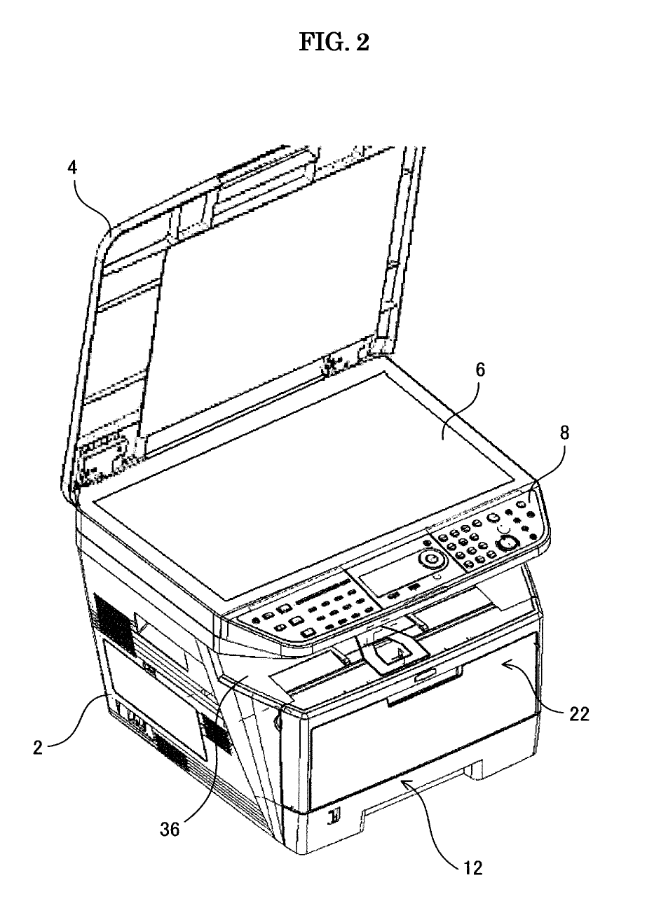

A document presser 4 is arranged on an upper portion of the device main body 2 of this embodiment, and a contact glass (document holding section) 6 is arranged on a lower side of the document presser 4 (FIG. 2).

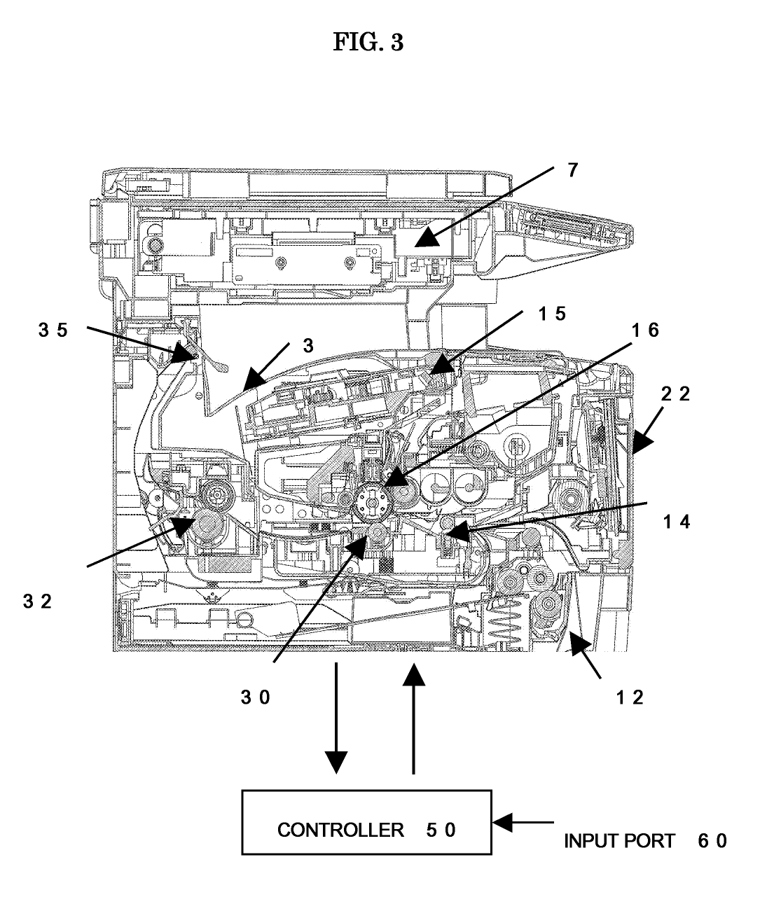

Image data of a document held on the contact glass 6 is optically read in a scanner section (image reading apparatus) 7 by a sensor such as a photoelectric conversion element (charge coupled device (CCD)) (not shown) (FIG. 3).

Note that, instead of the document presser 4, an automatic document feeder (ADF) for feeding a document to a predetermined image reading position can also be mounted on the main body.

On the near side of the contact glass 6, an operation panel 8 is installed.

In the operation panel 8, there are arranged a plurality of operation keys and switches serving for various operations by the operator and there is provided a display screen for displaying various pieces of information.

A sheet feed cassette 12 is arranged on a lower portion of the device main body 2.

The sheet feed cassette 12 is detachably formed with respect to the device main body 2. When the sheet feed cassette 12 is drawn toward the front side of the multifunction peripheral 1, the inside of the sheet feed cassette 12 is released to the outside.

Inside the sheet feed cassette 12, for example, plain sheets are accommodated in a stacked state.

On the other hand, a front cover 20 is arranged above the sheet feed cassette 12.

Specifically, the front cover 20 is formed in a gate shape covering the front side of the device main body 2, and a lower end portion thereof is pivotally supported by the device main body 2.

Further, the front cover 20 is provided with a manual feed tray 22. The manual feed tray 22 is formed so that the front cover 20 may be opened and closed.

In other words, when a handgrip provided to the manual feed tray 22 is gripped and the manual feed tray 22 is drawn toward the front side of the multifunction peripheral 1, the inside of the device main body 2 is released to the outside. When the handgrip is pushed toward the back side of the multifunction peripheral 1, the manual feed tray 22 is accommodated in the device main body 2.

The manual feed tray 22 is formed so as to stack special sheets such as cardboard.

As illustrated in FIG. 3, in the device main body 2, a registration roller 14, an image forming section 16, and a transfer section 30 are arranged in the stated order on the downstream side of a sheet feeding direction viewed from the sheet feed cassette 12 and the manual feed tray 22.

The image forming section 16 includes a photosensitive drum.

Further, an exposure section 15 is provided in the vicinity of the image forming section 16, and a laser beam is emitted from the exposure section 15 toward the photosensitive drum.

Further, the transfer section 30 includes a transfer roller. The transfer roller is formed so as to be pressed against the photosensitive drum.

The transfer roller and the photosensitive drum forms a nip portion for transferring a toner image to a sheet.

On the downstream side of the transfer section 30 viewed in the sheet feeding direction, a fixing section 32 and a sheet discharge tray 36 are arranged in the stated order.

When the multifunction peripheral 1 performs printing, plain sheets are separated one by one and sent from the sheet feed cassette 12, or special sheets from the manual feed tray 22.

The sheet, which is the sent plain sheet or the sent special sheet, arrives at the registration roller 14.

The registration roller 14 corrects diagonal feeding of the sheet and sends the sheet to the transfer section 30 while synchronizing the sheet sending with an image transfer timing of a toner image formed in the image forming section 16.

On the other hand, an input port 60 of FIG. 3 is formed so that image data, which is a source for printing, may be received from the outside or the scanner section 7.

The image data is obtained by converting various images such as a letter, a code, a figure, a symbol, a diagram, and a pattern, into data. Then, based on the data, a controller (main ECU) 50 controls the irradiation with the use of the laser beam.

The controller 50 is an element functioning as a computer, and includes hardware resources such as a central processing unit (CPU) and a memory.

Then, the controller 50 executes a predetermined program by using the hardware resources. With this execution, an electrostatic latent image of a document image is formed on the photosensitive drum in the image forming section 16, and subsequently a toner image is formed on the photosensitive drum from the electrostatic latent image.

The toner image is transferred onto a sheet in the nip portion. After that, the sheet is sent toward the fixing section 32 in a state where the sheet bears an unfixed toner image to be pressurized in the fixing section 32 with a heat roller having a predetermined temperature, whereby the toner image is fixed thereon.

Then, the sheet sent from the fixing section 32 is discharged to the sheet discharge tray 36 via a discharge roller 35.

Incidentally, the scanner section 7 described above is arranged on the lower side of the contact glass 6. The scanner section 7 includes a carriage 40 that moves in a horizontal direction (sub-scanning direction) along the contact glass 6, and reads the image data of the document by a sensor such as a photoelectric conversion element (charge coupled device (CCD)) (not shown).

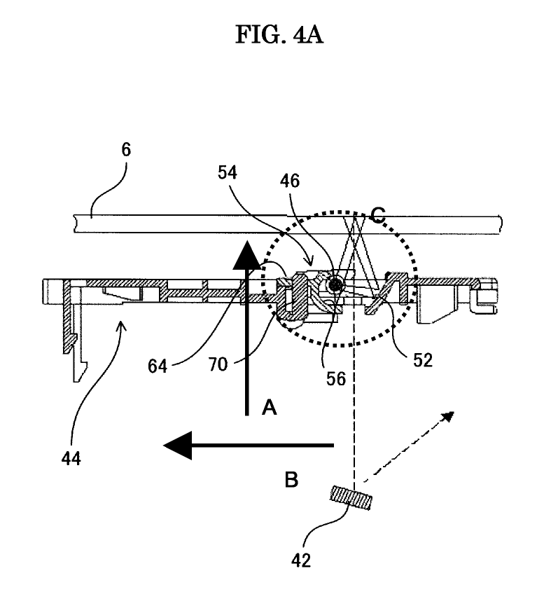

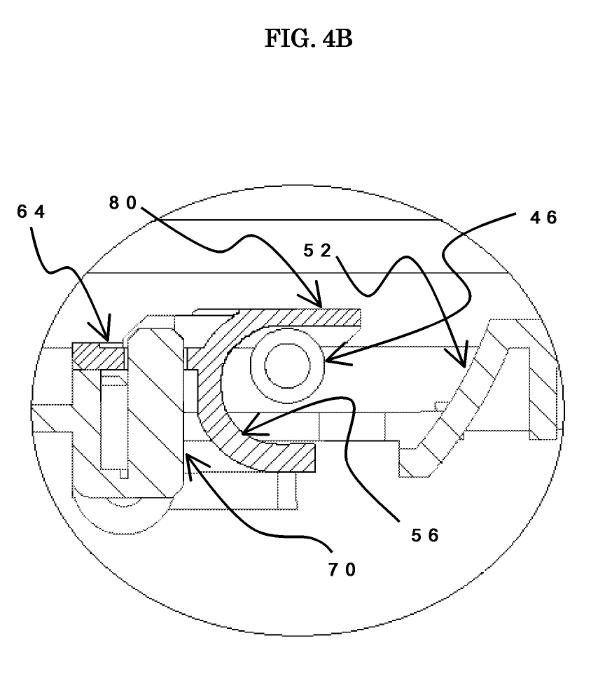

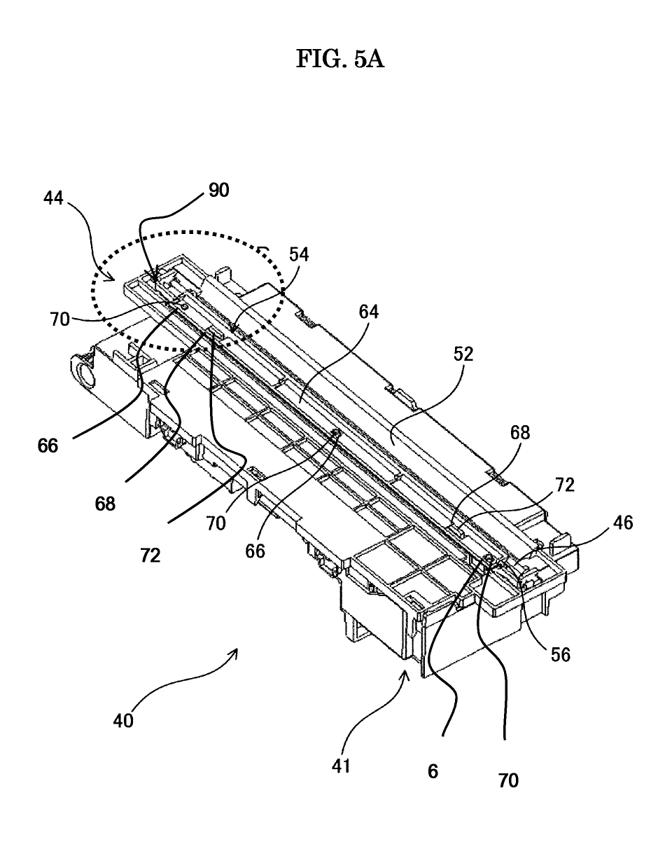

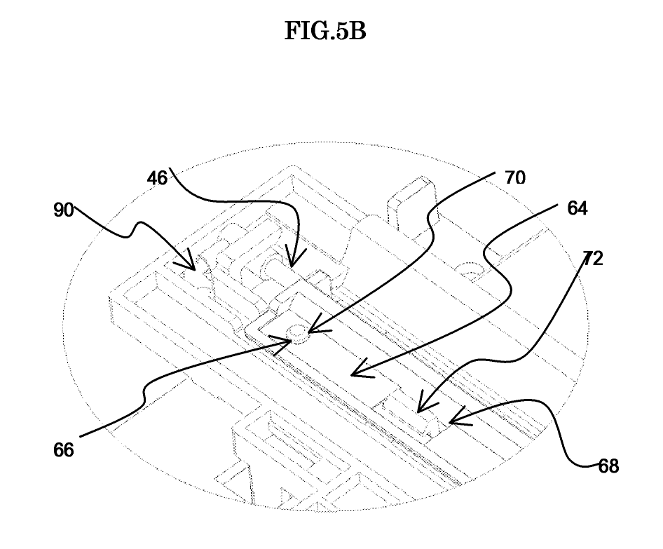

Specifically, as illustrated in FIGS. 4 and 5, the carriage 40 includes a housing 41, and moves in a direction substantially orthogonal to a longitudinal direction (main scanning direction) thereof by way of a drive motor or a timing belt (not shown).

The housing 41 is formed into a void with, for example, an ABS resin, and the inside thereof is provided with a plurality of lenses, a mirror 42, and a sensor such as a photoelectric conversion element (CCD).

The housing 41 has an upper portion covered by a light source mounting base 44, and the light source mounting base 44 has a function as a cover of the carriage 40. Further, a rod-like cold-cathode tube lamp (light source) 46 is installed in the light source mounting base 44.

Specifically, the cold-cathode tube lamp 46 is a light source having no reflective coat on an outer peripheral surface thereof. Both end portions in a longitudinal direction (tube length direction, main scanning direction) of the cold-cathode tube lamp 46 are supported by the light source mounting base 44, and are connected to an electric supply line 90 for supplying electrical power to the cold-cathode tube lamp 46.

The electric supply line 90 leads from the inside to the outside of the housing 41. In the outside of the housing 41, the electric supply line 90 is installed in the light source mounting base 44 along the cold-cathode tube lamp 46. On the other hand, in the inside of the housing 41, the electric supply line 90 is connected to a lighting circuit board (inverter board) (not shown).

A reflection plate 54, which collects light emitted from the cold-cathode tube lamp 46 toward the contact glass 6, is mounted to the light source mounting base 44.

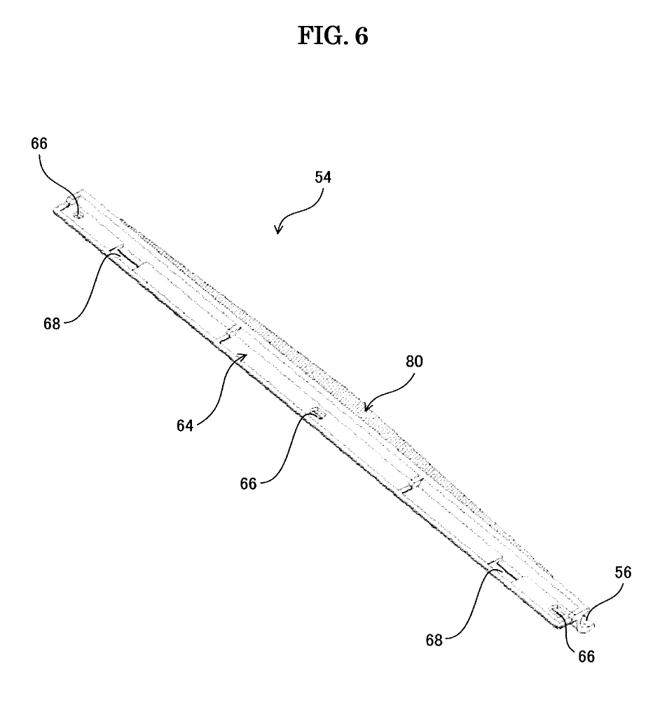

Specifically, the reflection plate 54 is formed of, for example, a white resin. As illustrated in FIG. 6, the reflection plate 54 is formed separately from the light source mounting base 44, and includes a reflection curved surface portion 56 and a support plate 64.

The reflection curved surface portion 56 is formed into a substantially C shape in sectional view (FIG. 4), and partially surrounds the left-half circumference (FIG. 4) of the cold-cathode tube lamp 46 over the main scanning direction, that is, longitudinal direction of the cold-cathode tube lamp 46.

The reflection curved surface portion 56 illustrated in FIG. 4 has a shape for obtaining a light collecting function.

Specifically, of the curved surface having the substantially C shape, a contact glass 6 side of the reflection curved surface portion 56 is arranged in a substantially upper side direction of the cold-cathode tube lamp 46 and extends counter clockwisely while having a predetermined space, and the mirror 42 side thereof is arranged in a substantially lower side direction of the cold-cathode tube lamp 46.

Here, the reflection curved surface portion 56 of this embodiment includes a longitudinal light distribution correcting portion (light reducing portion) 80 (FIG. 6) and reduces an amount of light at a longitudinal center portion of the cold-cathode tube lamp 46.

Specifically, as illustrated in FIGS. 4 and 6, the longitudinal light distribution correcting portion 80 is installed on the contact glass 6 side of the curved surface having the substantially C shape, and protrudes from an end of the reflection curved surface portion 56 on the contact glass 6 side to further surround the cold-cathode tube lamp 46.

More specifically, the longitudinal light distribution correcting portion 80 has a portion corresponding to the longitudinal center portion of the cold-cathode tube lamp 46, the portion protruding from the end of the reflection curved surface portion 56 toward a right direction (FIG. 6) of the cold-cathode tube lamp 46, when viewed from the contact glass 6 side, thereby further surrounding the cold-cathode tube lamp 46 and blocking an optical path of the longitudinal center portion.

On the other hand, a protrusion amount of the longitudinal light distribution correcting portion 80 is gradually reduced from the longitudinal center portion toward both longitudinal end portions of the cold-cathode tube lamp 46. The protrusion amounts of the both longitudinal end portions are substantially set to zero.

The support plate 64 is continuous with the outer peripheral surface of the reflection curved surface portion 56, and supports the reflection curved surface portion 56 over the longitudinal direction of the cold-cathode tube lamp 46.

Further, the support plate 64 has positioning holes 66 perforated therein at three portions, that is, a center portion and vicinities of both end portions. In addition, in this embodiment, engaging grooves 68 are formed therein at two portions between each two of the positioning holes 66 (FIGS. 5 and 6).

When the reflection plate 54 is mounted to the light source mounting base 44 from above the housing 41, the reflection curved surface portion 56 partially surrounds the cold-cathode tube lamp 46.

Moreover, when the positioning holes 66 of the support plate 64 are engaged with three positioning pins 70 vertically provided to the light source mounting base 44, and at the same time, when the engaging grooves 68 of the support plate 64 are engaged with two engaging claws 72 similarly vertically provided to the light source mounting base 44, the support plate 64 is fixed to the light source mounting base 44.

Note that positions of the positioning pins 70 and the positions of the engaging claws 72 may be exchanged with each other.

In other words, when the engaging grooves 68 are formed at the three portions of the support plate 64, that is, the center portion and the vicinities of the both end portions thereof and the positioning holes 66 are formed at the two portions between each two of the engaging grooves 68, the support plate 64 may be fixed to the light source mounting base 44 certainly.

Further, a sub-reflection plate 52 is arranged on a side opposite to the reflection plate 54 with the cold-cathode tube lamp 46 interposed therebetween. The sub-reflection plate 52 is fixed to the light source mounting base 44, and collects light from the cold-cathode tube lamp 46 toward the contact glass 6.

When the contact glass 6 is irradiated with direct light from the cold-cathode tube lamp 46 and reflected lights from the reflection plate 54 and the sub-reflection plate 52, a desired cross-sectional light distribution with an optical axis being in the center may be obtained.

In other words, the amount of light at the longitudinal center portion of the cold-cathode tube lamp 46 is slightly reduced. The irradiated lights are read by the sensor such as a photoelectric conversion element (CCD) via the mirror 42 or the lenses, thereby being converted into a predetermined signal. After that, the electrostatic latent image of the document image is formed on the photosensitive drum.

Incidentally, the longitudinal light distribution correcting portion 80 described above may also be provided to the support plate 64, in addition to being provided to the reflection curved surface portion 56.

Specifically, a longitudinal center portion of the reflection plate 54 is bent above (arrow “A” of FIG. 4A).

In other words, in the longitudinal light distribution correcting portion 80, the portion corresponding to the longitudinal center portion of the cold-cathode tube lamp 46 greatly protrudes from the light source mounting base 44 toward the contact glass 6, compared with the protrusion of the both longitudinal end portions thereof, and a distance between the cold-cathode tube lamp 46 and the reflection curved surface portion 56 is set to be larger than a distance of FIG. 4A.

This is because, in this case as well, the amount of light at the longitudinal center portion of the cold-cathode tube lamp 46 may be reduced.

On the other hand, with regard to the longitudinal light distribution correcting portion 80 to be provided to the support plate 64, the longitudinal center portion of the reflection plate 54 may be bent toward the left side (arrow “B” of FIG. 4A).

Specifically, of the positioning holes 66, only the positioning hole 66 at a portion corresponding to the longitudinal center portion of the cold-cathode tube lamp 46 is largely shifted toward a direction away from the cold-cathode tube lamp 46, whereby the amount of light at the longitudinal center portion of the cold-cathode tube lamp 46 may be reduced.

This is because, in this case as well, in the longitudinal center portion of the cold-cathode tube lamp 46, the distance between the cold-cathode tube lamp 46 and the reflection curved surface portion 56 becomes larger than the distance of FIG. 4.

As described above, according to this embodiment, the scanner section 7 includes the carriage 40 that moves with respect to the contact glass 6, and the carriage 40 includes the rod-like cold-cathode tube lamp 46 for irradiating the document, the light source mounting base 44 for supporting the cold-cathode tube lamp 46, the housing 41 provided with the sensor such as a photoelectric conversion element (CCD) for reading the image data of the document and with the light source mounting base 44, and the reflection plate 54.

The reflection plate 54 includes the reflection curved surface portion 56 and the longitudinal light distribution correcting portion 80. The reflection curved surface portion 56 partially surrounds the cold-cathode tube lamp 46 and corrects the light emitted from the cold-cathode tube lamp 46 toward the contact glass 6. The longitudinal light distribution correcting portion 80 reduces the amount of light at the longitudinal center portion of the cold-cathode tube lamp 46 with respect to the contact glass 6.

Further, the reflection plate 54 is provided to the light source mounting base 44 for supporting the cold-cathode tube lamp 46.

In addition, the sub-reflection plate 52 is arranged on the side opposite to the reflection plate 54 with the cold-cathode tube lamp 46 interposed therebetween.

Further, the sub-reflection plate 52 is provided to the light source mounting base 44.

Further, the reflection plate 54 includes the reflection curved surface portion 56 having the substantially C shape, and the longitudinal light distribution correcting portion 80 protruding from the end of the reflection curved surface portion 56 on the contact glass 6 side, as approaching from the both end portions toward the longitudinal center portion of the cold-cathode tube lamp 46.

The reflection plate 54 further includes the support plate 64 for supporting the reflection curved surface portion 56. In the support plate 64, a portion at the longitudinal center portion of the cold-cathode tube lamp 46 protrudes toward the contact glass 6 than portions at the both longitudinal end portions of the cold-cathode tube lamp 46.

Further, the reflection plate 54 further includes the support plate 64 for supporting the reflection curved surface portion 56, the support plate 64 being engaged with the light source mounting base 44. In the support plate 64, the engagement portion with the light source mounting base 44 at the longitudinal center portion of the cold-cathode tube lamp 46 is more distant from the cold-cathode tube lamp 46 than the engagement portions with the light source mounting base 44 at the both longitudinal end portions of the cold-cathode tube lamp 46.

With this structure, an appropriate shading correction is executed, and a desired cross-sectional light distribution in which the amount of light at the longitudinal center portion of the cold-cathode tube lamp 46 is reduced, may be obtained.

Further, the shading correction may be made by the use of a mechanical structure, instead of a correction of an electrical signal. Thus, the simplification of the control for the scanner section 7 is also achieved.

Moreover, with the use of the multifunction peripheral 1 including the above-mentioned scanner section 7, the unevenness in amount of light is less likely to be caused on the image data of the document read by the scanner section 7, which contributes to the improvement in reliability of the multifunction peripheral 1.

The embodiment of the present invention has been described above, but the present invention is not limited to the above-mentioned embodiment and encompasses the following points.

(1) In the above-mentioned embodiment, the multifunction peripheral has been exemplified as the image forming apparatus 1, but the image forming apparatus may be an apparatus such as a copying machine, a printer, a facsimile, or an inkjet. Further, the image forming apparatus may be a multifunction peripheral having a function as an apparatus such as a copying machine, a printer, a facsimile, or an inkjet.

(2) In the above-mentioned embodiment, the cold-cathode tube lamp has been exemplified as the light source 46, but the light source may be a rod-like light source such as a halogen lamp or a xenon lamp.

What is claimed is:

1. An image reading apparatus for reading a document, the image reading apparatus comprising:
a document holding section for holding the document; and
a carriage operable to move with respect to the document holding section, the carriage comprising:
a rod-like light source positioned and configured to irradiate the document with light;
a light source mounting base positioned and configured to support the light source;
a housing containing a sensor for reading image data of the document and the light source mounting base; and
a reflection plate comprising:
a reflection curved surface portion positioned and configured to partially surround the light source to collect light emitted from the light source toward the document holding section; and
a light reducing portion positioned and configured to reduce an amount of light at a longitudinal center portion of the light source with respect to the document holding section.

2. The image reading apparatus according to claim 1, wherein the light source comprises a cold-cathode tube lamp.

3. The image reading apparatus according to claim 1, wherein the reflection plate is positioned on the light source mounting base.

4. The image reading apparatus according to claim 1, further comprising a sub-reflection plate arranged on a side opposite to the reflection plate while sandwiching the light source therebetween.

5. The image reading apparatus according to claim 4, wherein the sub-reflection plate is positioned on the light source mounting base.

6. The image reading apparatus according to claim 1, wherein:
the reflection curved surface portion has a C shape; and
the light reducing portion protrudes from an end of the reflection curved surface portion on a document holding section side, as approaching from both longitudinal end portions toward the longitudinal center portion of the light source,

7. The image reading apparatus according to claim 1, further comprising:
a support plate positioned and configured to support the reflection curved surface portion and protruding toward the document holding section such that the longitudinal center portion of the light source protrudes than the both longitudinal end portions of the light source.

8. The image reading apparatus according to claim 1 further comprising:
a support plate positioned and configured to support the reflection curved surface portion, and engaged with the light source mounting base;
the support plate including engagement portions positioned and configured to engage with the light source mounting base an engagement portion at the longitudinal center portion of the light source being positioned apart from the light source than the engagement portions at the both longitudinal end portions of the light source.

9. An image forming apparatus comprising the image reading apparatus according to claim 1.
